(19) United States
(12) Patent Application Publication
(10) Pub. No.: US 2016/0167447 A1
(43) Pub. Date: Jun. 16, 2016

(54) Bicycle Air Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Sylvain PETIT JEAN, Clermont-Ferrand Cedex 9 (FR); Luc BESTGEN, Clermont-Ferrand Cedex 9 (FR); David OLSOMMER, Clermont-Ferrand Cedex 9 (FR)

(21) Appl. No.: 14/904,345

(22) PCT Filed: Jul. 10, 2014
(86) PCT No.: PCT/EP2014/064793

§ 371 Date: Jan. 11, 2016

(30) Foreign Application Priority Data
Jul. 12, 2013 (FR) 1356850

(51) Int. Cl. B60C 13/02; B60C 1/00

(52) U.S. Cl. CPC B60C 13/02; B60C 1/0025

(57) ABSTRACT

Bicycle tire comprising continuous toothing (5) cooperating with complementary toothing of a drive pinion of an electric assist device. The toothing has a substantially radial generatrix (G) with respect to the rotation axis of the tire in the axial direction (YY′). Toothing (5) is positioned circumferentially on an axially outer face (31) of at least one sidewall (3) and comprises teeth (51) having height h and length l, and comprising an elastomeric material having a Shore A hardness. The height h of teeth (51) is at least equal to 0.6 mm and at most equal to 3 mm. The length l of teeth (51) is at least equal to 0.15 times and at most equal to 0.50 times the section width S of the tire. The elastomeric material of teeth (51) has a Shore A hardness of at least equal to 55 and at most equal to 85.

The present invention relates to a bicycle tire and, more particularly, to a bicycle tire intended to cooperate with an electric assist device.

An electric assist device is understood to be an electrical device that is mounted on the bicycle and is able to rotate at least one wheel of the bicycle.

Document DE-20314210-U1 describes a principle of driving a bicycle by way of an electric assist device or electric motor in which a drive pinion meshes with a toothing integral with the front rim of the bicycle, said toothing being an internal toothing, i.e. the teeth point towards the wheel axis. A drawback of this device is that the toothing on the rim is liable to retain stones.

Documents DE-4011567-A1 and U.S. Pat. No. 5,165,776 describe an electric generator device for the lights of a bicycle, said device being intended to cooperate with a tire comprising a toothing with a radial generatrix, said toothing being positioned circumferentially on a sidewall of the tire and being intended to cooperate with a complementary toothing of a pinion of the electric generator device. The toothing positioned on the tire sidewall is designed to rotate the free pinion of the electric generator device. However, this toothing is not designed to be rotated by the drive pinion of an electric assist device.

The object of the invention is to propose a bicycle tire comprising a toothing having a substantially radial generatrix, said toothing being positioned circumferentially on a sidewall of the tire and being intended to cooperate with a complementary toothing of a drive pinion of a bicycle electric assist device.

To this end, the invention proposes a bicycle tire having a section width S, comprising:

two sidewalls connecting a tread to two beads,

a continuous toothing having a substantially radial generatrix with respect to the rotation axis of the tire, said toothing being positioned circumferentially on an axially outer face of at least one sidewall and comprising teeth,

the teeth having a height h and a length l and comprising an elastomeric material having a Shore A hardness,

the height h of the teeth being at least equal to 0.6 mm and at most equal to 3 mm, the length l of the teeth being at least equal to 0.15 times and at most equal to 0.50 times the section width of the tire, and the elastomeric material of the teeth having a Shore A hardness of at least equal to 55 and at most equal to 85.

The external geometry of a tire is, in particular, characterized by the section width of the tire, which is the axial distance between the axially outermost points of the sidewalls of the tire. An axial distance is a distance measured parallel to the rotation axis of the tire. The axially outermost points are the two furthest-apart points, in the axial direction, of the equatorial plane of the tire, the equatorial plane passing through the middle of the tread perpendicularly to the rotation axis of the tire. This axial distance is measured on a tire mounted on its rim and inflated to its service pressure, within the meaning of the standards of the European Tire and Rim Technical Organization or ETRTO.

The sidewalls are the lateral portions of a tire that connect the tread, intended to come into contact with the ground, to the beads, intended to come into contact with a rim.

A toothing is geometrically defined by a generatrix. For a toothing according to the invention, the generatrix is substantially radial, i.e. it forms a small angle with the radial direction of the tire, perpendicular to the axial direction of the rotation axis of the tire. More specifically, a substantially radial generatrix forms an angle of at most equal to 45° with the direction that is tangential to the axially outer face of the sidewall and situated in a meridian or radial plane of the tire perpendicular to the rotation axis of the tire. The axially outer face of the tire sidewall is the face of the sidewall in contact with atmospheric air, by contrast with the axially inner face of the sidewall in contact with the inflation air of the tire.

Moreover, this toothing is circumferentially positioned on an axially outer face of at least one sidewall of the tire, i.e. in the circumferential direction, the circumferential direction being tangential to the running surface of the tire and oriented in the running direction of the tire.

More specifically, the toothing is a juxtaposition of teeth. Each tooth is geometrically characterized by a length l, measured along the generatrix of the toothing, and by a height h, measured in a plane perpendicular to the generatrix. The length l of the teeth defines the maximum possible meshing length with a complementary toothing. The height h of the teeth defines the maximum possible meshing depth with a complementary toothing.

According to the invention, the height h of the teeth is at least equal to 0.6 mm and at most equal to 3 mm and the length l of the teeth is at least equal to 0.15 times and at most equal to 0.50 times the section width S of the tire.

These respective ranges of values for the height h and the length l of the teeth imply that the contact surface between a tooth of the toothing of the tire and a tooth of the complementary toothing of the pinion of the electric assist device, with which the toothing of the tire is intended to cooperate, is in a range of values making it possible to transmit the torque generated by the electric assist device to the wheel. These ranges of values for the height h and the length l take into account size constraints for positioning the toothing on the sidewall of the tire.

Also according to the invention, the elastomeric material of the teeth has a Shore A hardness of at least equal to 55 and at most equal to 85. Shore A hardness is a mechanical characteristic of an elastomeric material measured in accordance with standard DIN 53505.

A minimum Shore A hardness value ensures minimal flexural rigidity, about the generatrix of the toothing, for transmitting the torque generated by the electric assist device to the wheel, for a given tooth length and height. A maximum Shore A hardness value limits the impact of the toothing on the rigidity of the sidewall of the tire, in the circumferential direction, and consequently on the comfort of the cyclist.

The combination of the respective ranges of values for the height of the teeth, the length of the teeth and the Shore A hardness of the elastomeric material of which the teeth consist makes it possible to transmit to the wheel a drive torque generated by the electric assist device that can reach a value of 50 Nm or even 60 Nm.

Preferably, the elastomeric material of the teeth has a Shore A hardness of at least equal to 66 and at most equal to 80. This range of Shore A hardness values provides a good compromise between the flexural rigidity of the teeth and the flexural rigidity of the sidewalls.

The pitch p of the toothing is advantageously at least equal to 1.8 mm and at most equal to 5.5 mm. The pitch p of the toothing is the distance measured between the tops of two consecutive teeth in a plane perpendicular to the generatrix G.

It has been found that the greater the pitch of the toothing, the more it generates significant noise. On the other hand, a greater pitch is more tolerant of a misalignment between the toothing of the tire and the complementary toothing of a pinion. Furthermore, a greater pitch is less sensitive to the presence of foreign bodies such as snow or mud, for example, which are more easily removed. By contrast, a smaller pitch is quieter but less tolerant of misalignment or the presence of foreign bodies. The range of values recommended for the pitch of the toothing therefore makes it possible to obtain a toothing that efficiently transmits torque, is relatively quiet and tolerant of misalignment or the presence of foreign bodies.

The pitch p of the toothing is even more advantageously at least equal to 2 mm and at most equal to 3 mm. This preferred range of values for the pitch of the toothing makes it possible to optimize the compromise between efficiency, noise and tolerance of the environment of the toothing. By way of example, a toothed-section pitch of 2.3 mm has provided good results with regard to this compromise.

It is likewise advantageous for the generatrix of the toothing to form an angle of at least equal to 4° and at most equal to 40° with the direction of the radial plane tangential to the axially outer face of the sidewall. This angle corresponds to the helix angle of the helical toothing.

This inclination of the generatrix of the toothing with respect to the direction of the radial plane tangential to the axially outer face of the sidewall increases the contact ratio between the toothing of the tire and the complementary toothing of the pinion. Thus, the noise generated is substantially reduced compared with a toothing having a strictly radial generatrix, i.e. one forming a zero angle with respect to the radial direction.

It is even more advantageous for the generatrix of the toothing to form an angle of at least equal to 15° and at most equal to 30° with the direction of the radial plane tangential to the axially outer face of the sidewall. An angle of 25° is a particularly advantageous configuration in terms of noise generated.

Advantageously, the teeth of the toothing comprise driving faces and non-driving faces, the opening angle of the driving faces being at most equal to the opening angle of the non-driving faces.

In cross section perpendicular to the generatrix of the toothing, each tooth has a substantially triangular profile, a first side of which is the base of the triangle, positioned on the sidewall, and the other two sides of which are the driving face and non-driving face, respectively. The driving face is the face on which the contact pressure of the complementary toothing is exerted, the non-driving face being the other face which is not subjected to this contact pressure. The driving face and non-driving face each form an opening angle with the direction perpendicular to the base.

An opening angle of a driving face at most equal to the opening angle of a non-driving face makes it possible to obtain a non-symmetric profile of the tooth, making it possible to transmit a drive torque greater than that obtained with a symmetric profile of the tooth. Specifically, a non-symmetric profile causes less bending of the tooth than a symmetric profile, and hence greater transmission of force.

It is more advantageous for the driving faces and non-driving faces of the teeth to have a rectilinear profile. Specifically, a rectilinear face has a larger contact surface with the complementary toothing and thus makes it possible to transmit a greater torque.

It is likewise advantageous for the driving faces and non-driving faces of the teeth to have a curvilinear profile. Specifically, curvilinear faces make it possible to increase the flexural rigidity of the tooth and thus make it possible to transmit a greater torque.

The driving and non-driving faces may likewise have a profile combining the rectilinear and curvilinear parts in order to combine the above-described advantages.

The generatrix of the toothing may likewise be curvilinear in order to increase the meshing length compared with a generally rectilinear generatrix, resulting in a potential increase in torque transmission.

According to a preferred embodiment, the toothing comprises a textile material, preferably of the aliphatic polyamide type.

The textile material is preferably an aliphatic polyamide or nylon, which is a material commonly used in the tires field on account of its cost and its compatibility with elastomeric materials.

A textile material is most often in the form of a fabric. However, it can also be formed by dispersed reinforcements.

The presence of a textile material, in addition to the elastomeric material, makes it possible to improve the abrasion resistance of the toothing, resulting from meshing cycles. It also makes it possible to reduce the noise generated by way of a damping effect of the textile material. Finally, in terms of manufacture, a textile material having orthotropic elasticity follows the deformations during the moulding of the shape of the tooth, in the course of the shaping of the tire during the curing thereof.

According to a preferred variant of the preferred embodiment, the toothing comprises, axially on the outside of the elastomeric material, a textile material, preferably of the aliphatic polyamide type.

A textile material, positioned on the outside of the elastomeric material, has the advantage of being easy to fit. Moreover, it makes it possible to increase the efficiency of the transmission by affording better slip between the toothing of the tire and the complementary toothing, thereby reducing frictional losses by way of a lubricating effect.

The features and other advantages of the invention will be better understood with the aid of the appended schematic figures which are not shown to scale, in which:

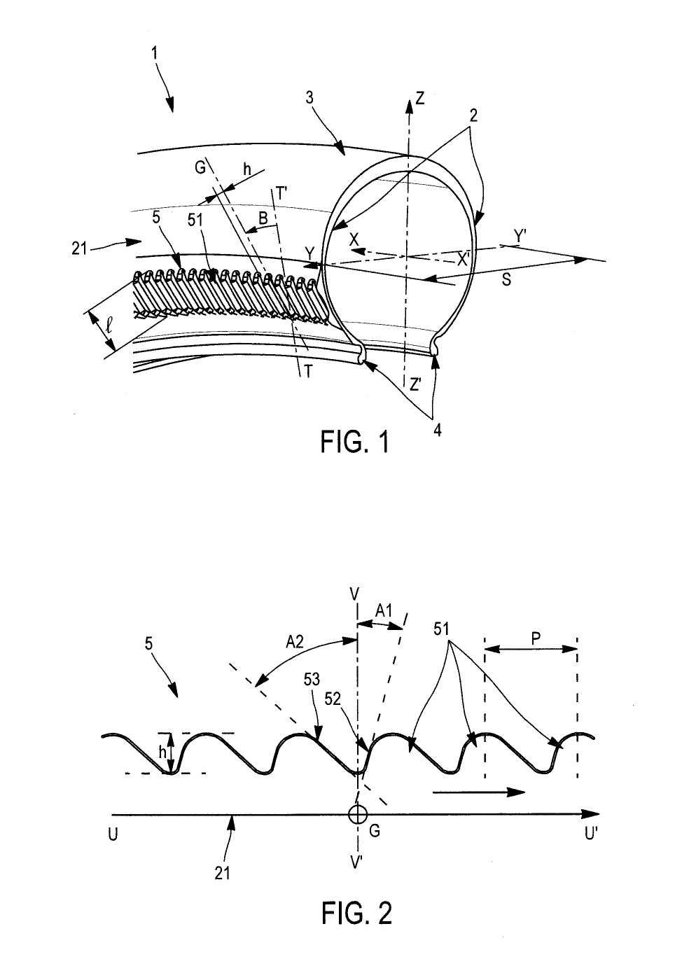

FIG. 1 shows a perspective view of a bicycle tire portion comprising a toothing according to the invention,

FIG. 2 is a view in cross section of a toothing according to the invention, in a section plane perpendicular to the generatrix of the toothing,

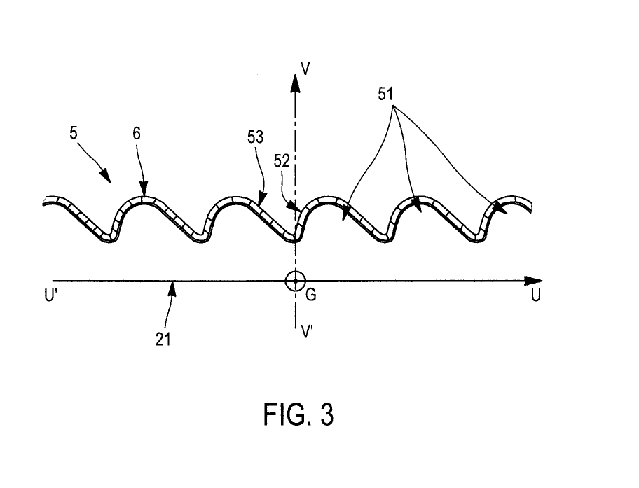

FIG. 3 is a view in cross section of a toothing according to the invention, comprising a textile material, in a section plane perpendicular to the generatrix of the toothing.

FIG. 1 shows a tire portion 1 comprising a toothing 5 according to the invention. The tire 1 comprises two sidewalls 2 connecting a tread 3, intended to come into contact with the ground (not shown), to two beads 4 that are intended to come into contact with a mounting rim (not shown). The directions XX′, YY′ and ZZ′ respectively denote the circumferential direction, tangential to the tread 3 of the tire and oriented in the running direction of the tire, the axial direction, parallel to the rotation axis (not shown) of the tire, and the radial direction, perpendicular to the rotation axis of the tire. The tire 1 has a section width S, measured in the axial direction YY′, between the axially outermost points of the axially outer faces 21 of the sidewalls 2. The tire 1 comprises a continuous toothing 5 having a substantially radial generatrix G with respect to the rotation axis of the tire in the axial direction YY′, said toothing 5 being positioned circumferentially, in the direction XX′, on an axially outer face 21 of at least one sidewall 2. The generatrix G forms an angle B, with the direction TT′, which is positioned in the radial or meridian plane YZ and tangential to the axially outer face 21 of the sidewall 2. The toothing 5 comprises teeth 51 having a height h and a length l, the teeth 51 comprising an elastomeric material having a Shore A hardness.

According to the invention, the height h of the teeth 51 is at least equal to 0.6 mm and at most equal to 3 mm, the length l of the teeth 51 is at least equal to 0.15 times and at most equal to 0.50 times the section width S of the tire, and the elastomeric material of the teeth (51) has a Shore A hardness of at least equal to 55 and at most equal to 85.

FIG. 2 is a view in cross section of a toothing 5 according to the invention, in a section plane UV perpendicular to the generatrix G of the toothing 5. The toothing 5 consists of a juxtaposition of teeth 51 spaced apart at a pitch p. The pitch p is the distance measured between the tops of two consecutive teeth 51 in the direction UU′ parallel to the axially outer face 21 of the sidewall 2. Each tooth 51 has a height h, measured between the base and the top of the tooth 51, in the direction VV′ perpendicular to the axially outer face 21 of the sidewall 2. Each tooth 51 comprises a driving face 52 and a non-driving face 53. In the embodiment shown in FIG. 2, the opening angle A₁ of the driving face 52, with respect to the direction VV′, is less than the opening angle A₂ of the non-driving face 53, with respect to the direction VV′. Moreover, FIG. 2 illustrates teeth having rectilinear driving faces and non-driving faces. In the case of a curvilinear face, the above-described opening angle should be measured between the tangent to the point of the curvilinear face corresponding to the tooth half height and the direction VV′.

FIG. 3 is a view in cross section of a toothing 5 according to the invention, comprising a textile material, in a section plane UV perpendicular to the generatrix G of the toothing 5. The embodiment in FIG. 3 differs from that in FIG. 2 in that the toothing 5 comprises, axially on the outside of the elastomeric material, a textile material 6, preferably of the aliphatic polyamide type. The textile material 6 used is a fabric of the aliphatic polyamide or nylon type.

A number of toothing configurations, the design of which has been optimized by finite-element simulations, have been tested by the inventors for a bicycle tire of the size 37-622.

In a first example of a toothing, the teeth have a height of 1.2 mm, a length of 7.5 mm and a pitch of 3 mm. They consist of an elastomeric material having a Shore A hardness of between 66 and 80. This first example of a toothing makes it possible to transmit a drive torque of around 20 Nm.

In a second example of a toothing, the teeth have a height of 0.94 mm, a length of 10 mm and a pitch of 2.3 mm. They consist of an elastomeric material having a Shore A hardness of between 66 and 80. This second example of a toothing likewise makes it possible to transmit a drive torque of around 20 Nm.

The invention has been substantially described for a toothing 5 positioned in the vicinity of the bead 4 of the tire, in the radially inner part of the sidewall 2. Alternatively, the toothing 5 can be positioned on the shoulder of the tire, i.e. in the vicinity of the tread 3, or at the centre of the tread, in the equatorial plane.

The invention has been substantially described with reference to a bicycle tire but may be extended to any tire, or to any solid tire, i.e. an uninflated tire, intended to cooperate with an electric assist device in order to motorize small vehicles for transporting persons, such as electric scooters, electric wheelchairs, etc. For an electric wheelchair application, the opening angles A₁ and A₂ of the driving faces and non-driving faces, respectively, of the teeth should be similar in order to allow a significant torque to be transmitted to the wheel not just when travelling forwards but also in reverse.

1. A bicycle tire having a section width S, comprising:
two sidewalls connecting a tread to two beads;
a continuous toothing having a substantially radial generatrix with respect to the rotation axis of the tire in the axial direction, said toothing being positioned circumferentially on an axially outer face of at least one sidewall and comprising teeth;
the teeth having a height h and a length l and comprising an elastomeric material having a Shore A hardness,
wherein the height h of the teeth is at least equal to 0.6 mm and at most equal to 3 mm, the length l of the teeth being at least equal to 0.15 times and at most equal to 0.50 times the section width S of the tire, and the elastomeric material of the teeth having a Shore A hardness of at least equal to 55 and at most equal to 85.

2. The bicycle tire according to claim 1, wherein the elastomeric material of the teeth has a Shore A hardness of at least equal to 66 and at most equal to 80.

3. The bicycle tire according to claim 1, the toothing having a pitch p between two consecutive teeth, wherein the pitch p of the toothing is at least equal to 1.8 mm and at most equal to 5.5 mm.

4. The bicycle tire according to claim 1, the toothing having a pitch p between two consecutive teeth, wherein the pitch p of the toothing is at least equal to 2 mm and at most equal to 3 mm.

5. The bicycle tire according to claim 1, wherein the generatrix of the toothing forms an angle of at least equal to 4° and at most equal to 40° with the direction of the radial plane being tangential to the axially outer face of the sidewall.

6. The bicycle tire according to claim 1, wherein the generatrix of the toothing forms an angle of at least equal to 15° and at most equal to 30° with the direction of the radial plane tangential to the axially outer face of the sidewall.

7. The bicycle tire according to claim 1, wherein the teeth of the toothing comprise driving faces and non-driving faces, the opening angle of the driving faces being at most equal to the opening angle of the non-driving faces.

8. The bicycle tire according to claim 7, wherein the driving faces and the non-driving faces of the teeth have a rectilinear profile.

9. The bicycle tire according to claim 7, wherein the driving faces and the non-driving faces of the teeth have a curvilinear profile.

10. The bicycle tire according to claim 1, wherein the generatrix of the toothing is curvilinear.

11. The bicycle tire according to claim 1, wherein the toothing comprises a textile material.

12. The bicycle tire according to claim 1, wherein the toothing comprises, axially outside the elastomeric material, a textile material.

13. The bicycle tire according to claim 1, wherein the toothing comprises a textile material of the aliphatic polyamide type.

14. The bicycle tire according to claim 1, wherein the toothing comprises, axially outside the elastomeric material, a textile material, of the aliphatic polyamide type.
